(19) United States
(12) Patent Application Publication
(10) Pub. No.: US 2011/0264586 A1
(43) Pub. Date: Oct. 27, 2011

(54) SYSTEM AND METHOD FOR MULTIPATH CONTACTLESS TRANSACTIONS

(75) Inventors: Christopher Boone, San Francisco, CA (US); Dan Kikinis, (US); Perry Gregg, Davis, CA (US); Richard C. DeGolla, (US)

(73) Assignee: Cimbal Inc.

(21) Appl. No.: 13/174,733

(22) Filed: Jun. 30, 2011

Related U.S. Application Data
(63) Continuation-in-part of application No. 12/931,788, filed on Feb. 10, 2011.
(60) Provisional application No. 61/303,313, filed on Feb. 11, 2010.
(60) Provisional application No. 61/517,911, filed on Apr. 26, 2011.

(51) Int. Cl. G06Q 30/00; H04L 9/32; G06Q 20/00

(52) U.S. Cl. 705/67; 705/16; 705/14.36

(57) ABSTRACT

A system for multipath contactless transaction processing, comprising a point-of-sale system comprising a processing unit and a video screen, the video screen at least sometimes viewable by a purchaser interacting with the point-of-sale processing system, wherein, during a transaction, a graphical indicia is displayed on the video screen in a form suitable for photographing or scanning by a device held by the purchaser, and wherein, upon receipt by the point-of-sale processing unit of at least one non-graphical indicia the content of which is determined at least in part by the contents of the graphical indicia that was displayed to the purchaser, the point-of-sale completes the transaction.

### CROSS-REFERENCE TO RELATED APPLICATIONS

The present invention claims priority to provisional application Ser. No. 61/517,911 titled “System and Method for Multipath Contactless Transactions,” filed on Apr. 26, 2011, and is a continuation-in-part of U.S. application Ser. No. 12/931,788 titled “System and Method for Using Machine-Readable Indicia to Provide Additional Information and Offers to Potential Customers:”, filed on Feb. 10, 2011, which claims priority to provisional application Ser. No. 61/303,313, filed on Feb. 11, 2010. The disclosure of each of the above-referenced patent applications is hereby incorporated by reference in its entirety.

### BACKGROUND OF THE INVENTION

1. Field of the Invention

The invention is in the field of mobile computing applications, and more particularly in the field of mobile commerce applications enabling merchants to exchange valuable information with retail consumers.

2. Discussion of the State of the Art

Many retail stores and manufacturers maintain valuable online resources, where one can find descriptions and specifications of the merchandise offered by merchants and manufacturers, and reviews, and ratings of such merchandise. To facilitate sales the stores are interested in providing such information to their visitors while they are in the store.

This goal can be achieved with web-enabled mobile devices, such as smart phones with embedded cameras. A merchant application provides software, which can read optical codes, one-dimensional or two-dimensional barcodes for example, associated with the merchandise offered by the merchant or manufacturer, and then convert the code into a URL or similar link to information on the merchant website, for example. Such optical code and information retrieval methodology would be a working solution for a single merchant or manufacturer. In reality, there are many merchants, each with different coding conventions, and a customer would need to download and manage multiple custom merchant applications, which is cumbersome and inconvenient.

Further, it's required that production using a scanning bar code use a cryptographic nonce, which in security engineering is an abbreviation for “number used once,” for the financial transaction part, because third parties may be able to see or take an image of the code. A nonce is often a random or pseudo-random number issued in an authentication protocol to ensure that old communications cannot be reused in replay attacks.

What is needed is a system and method that can contextualize a scanned bar code or other suitable machine readable data with additional information, such as location, merchant, etc., and provide additional detail and price information, etc., as well as rebates or other promotional material to a potential buyer.

### SUMMARY OF THE INVENTION

According to a preferred embodiment of the invention, the inventors conceived a solution to the problems outlined above, and herein disclose a system for multipath contactless transaction processing, comprising a point-of-sale system comprising a processing unit and a video screen, the video screen at least sometimes viewable by a purchaser interacting with the point-of-sale processing system. According to the embodiment, during a transaction, a graphical indicia is displayed on the video screen in a form suitable for photographing or scanning by a device held by the purchaser and, upon receipt by the point-of-sale processing unit of at least one non-graphical indicia the content of which is determined at least in part by the contents of the graphical indicia that was displayed to the purchaser, the point-of-sale completes the transaction. According to another embodiment, an identity of the purchaser is provided within the non-graphical indicia. According to yet another embodiment, an information element displayed on the video screen after receipt of the non-graphical indicia is based at least in part on the identity of the purchaser. According to yet another embodiment, the information element displayed is based at least in part on the membership of the identified purchaser within a group. According to yet another embodiment of the invention, at least one purchase price of an item within the transaction is adjusted based on the identity of the purchaser.

According to another preferred embodiment, the system further comprises a near-field communications radio device and, in addition to receipt by the point-of-sale processing unit of the at least one non-graphical indicia, and subsequent to a transmitted request from the radio device, at least one response is received by the radio device specific to the request, and completion of the transaction by the point-of-sale device is performed only upon receipt of both the non-graphical indicia and the response received by the radio device.

According to another preferred embodiment of the invention, a system for multipath contactless transactions, comprising a server connected to a packet-based data network and adapted to communicate via the network with a plurality of merchant database systems and to a plurality of point-of-sale systems, a software module operating on the server, and a data store coupled to the server, is disclosed. According to the embodiment, on receipt of a transaction request from a point-of-sale system, the software module computes a cryptographic nonce and sends the nonce to the point-of-sale system and, on receipt of a response from a device other than the point-of-sale system that includes a first indicia based at least on the content of the cryptographic nonce, the software module validates the response and sends a message to the point-of-sale system containing at least a second indicia based at least in part on an identity of the user of the device. According to another embodiment, the second indicia is also based at least in part on membership of the user of the device in a group. According to yet another embodiment, the second indicia is also based at least in part on financial information provided in the response and is used to authorize the transaction. According to yet another embodiment, an image of the identified user of the device is transmitted by the software module to the point-of-sale system either as part of the second indicia or as a separate message.

According to a preferred embodiment of the invention, a method for conducting contactless transactions is disclosed, comprising the steps of (a) receiving, at a server, a first message indicating a pending transaction has commenced at a point-of-sale system; (b) computing, in a software module operating on or in communication with the server, a cryptographic nonce for the transaction; (c) transmitting the cryptographic nonce to the point-of-sale system in a second message; (d) receiving a third message from a device other than the point-of-sale system comprising information known to be derived from the cryptographic nonce and at least information pertaining to an identity of a user of the other device; (e) determining whether the user is authorized to complete out the pending transaction; and (f) sending a fourth message to the point-of-sale system comprising at least an authorization code or a rejection code for the pending transaction.

According to another embodiment of the invention, the method further comprises the steps between steps (d) and (e) of (d1) determining whether the user is a member of a group; (d2) transmitting an indicia of group membership to the point-of-sale system; and (d3) receiving a proposed total amount of the pending transaction from the point-of-sale system.

### BRIEF DESCRIPTION OF THE DRAWING FIGURES

FIG. 1 is a block diagram of a system according to a preferred embodiment.

FIG. 2 is a block diagram of a system involving multiple commercial entities, according to an embodiment of the invention.

FIG. 3 is an illustration of various two-dimensional coding arrangements, according to various embodiments of the invention.

FIG. 4 is an illustration of a method of providing information to a consumer based on codes associated with merchandise in a retail establishment, according to an embodiment of the invention.

FIG. 5 is a process flow diagram detailing a method for enabling multipath contactless transactions, according to an embodiment of the invention.

FIG. 6 is a block diagram illustrating an alternative arrangement involving a service provider and various retail establishments, according to a preferred embodiment.

FIG. 7 is a detailed diagram showing a system and method for multipath contactless transactions, according to an embodiment of the invention.

FIG. 8 is a detailed diagram showing a system and method for multipath contactless transactions in which a user is a member of a loyalty program, according to an embodiment of the invention.

FIG. 9 is a process flow diagram illustrating an alternative method for enabling multipath contactless transactions, according to an embodiment of the invention.

FIG. 10 is a process flow diagram illustrating another alternative method for enabling multipath contactless transactions, according to an embodiment of the invention.

### DETAILED DESCRIPTION

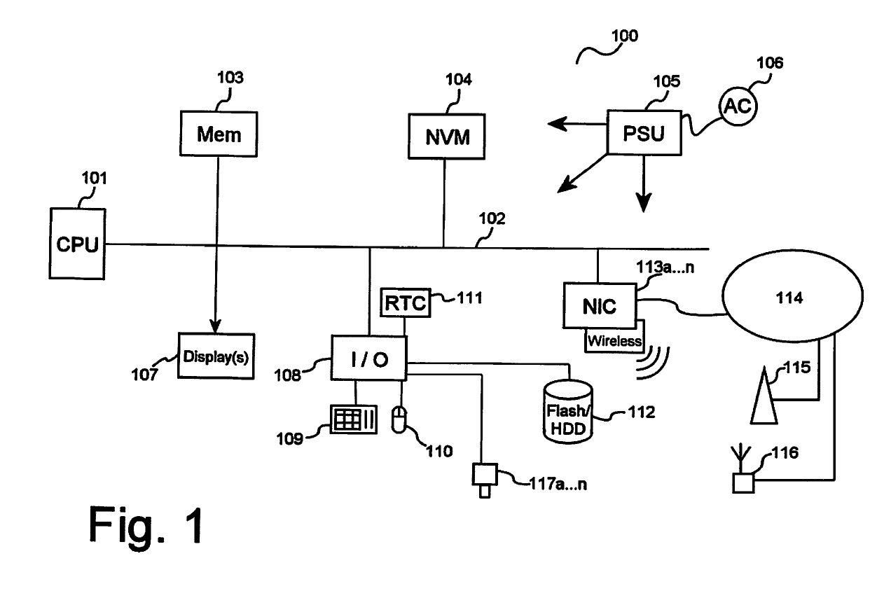

FIG. 1 shows a computer system 100, according to one aspect of the system and method described herein. Computer system 100 is exemplary of any computer that may execute code to process data. Various modifications and changes may be made to computer system 100 without departing from the broader spirit and scope of the system and method disclosed herein. Central processing unit (CPU) 101 is connected to bus 102, to which bus is also connected memory 103, nonvolatile memory 104, display 107, input/output (I/O) unit 108, and network interface card (NIC) 113. I/O unit 108 may, typically, be connected to an input device 109, such as a keyboard, a touch screen, buttons, and the like, as well as a mouse or other suitable graphical input device 110, hard disk (or in some cases other suitable storage, including, but not limited to solid state disk, RAID, network attached storage, storage area network, etc.) 112, one or more cameras 117a-n, and real-time clock 111. One or more network cards/interfaces 113a-n, some of which may be wireless, may connect to wide area networks (WANs) 115 or wireless local area networks (LANs) 116, all of which are connected via Internet 114 or any similar public or private packet-based data network. Also shown as part of system 100 is power supply unit 105 connected, in this example, to alternating current (AC) supply 106. Not shown are batteries that could be present, and many other devices, including but not limited to special enhanced pointing or navigational devices, such as mice, jog wheels; and the like, as well as microphone(s) and speaker(s) and/or headset(s) for recording and or playing back audio, and other modifications that are well known but are not applicable to the specific novel functions of the current system and method disclosed herein.

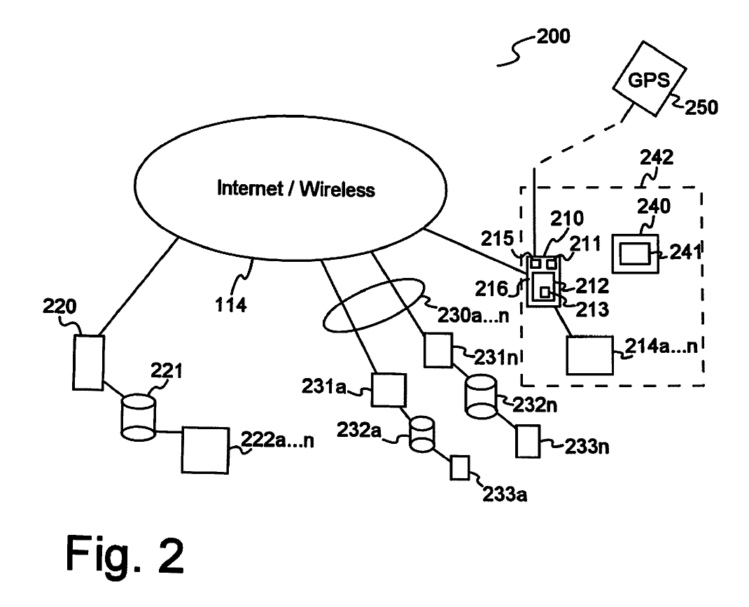

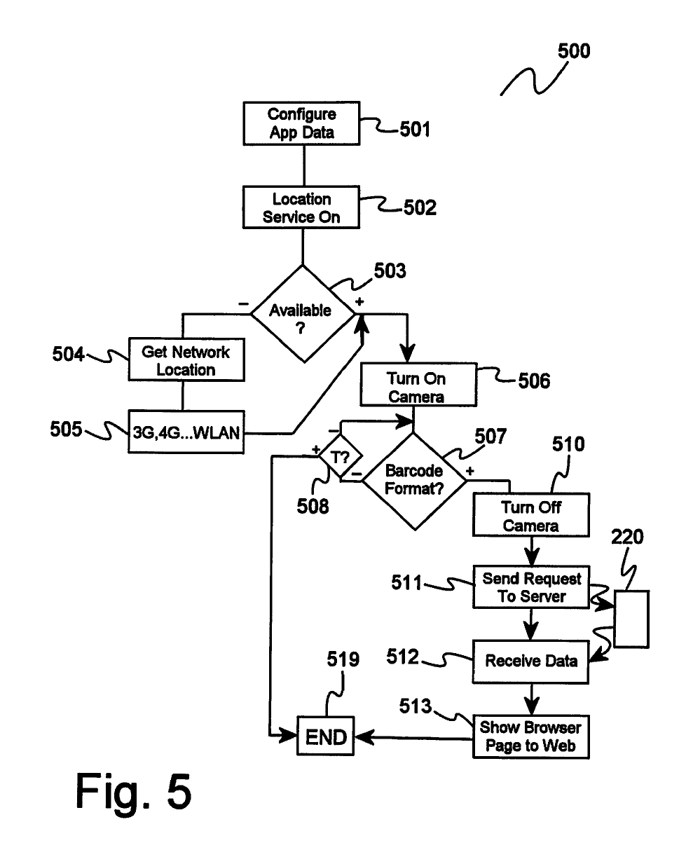

FIG. 2 shows an overview of an exemplary system 200, according to a preferred embodiment of the invention. Wireless Internet 114 is configured, according to the embodiment, as one conglomerate network, even though it is clear that multiple carriers and other wireless LANs may be offered; one having ordinary skill in the art will understand that there are many alternative network architectures that could be used without departing from the scope of the invention as claimed below. An operating center has a server 220 with mass storage 221 and programs 222a-n that are used to provide services according to various embodiments of the invention, which services are is described later, in the discussion of FIG. 5. Note that server 220 has a structure similar to the computer discussed in FIG. 1. Multiple systems of different merchants (some of which are participating actively in a promotional program using the system and method disclosed herein) are connected to the Internet via connections 230a-n. Each merchant has its own web service system 231a-n (in some cases, the merchants may have their own web infrastructure; in other cases, they may use cloud-based services, etc., which may appear as virtual servers). Servers 231a-n may have a structure similar to the computer discussed in FIG. 1. Each web service system 231a-n (whether real or virtual) has its own storage 232a-n and its own sets of software 233aa-an through 233na-nn. Also shown is a user with a device 210, which device could be a smart phone with a structure similar to the computing device discussed in FIG. 1. Device 210 contains, in this example, software 214a-n, one or more cameras 211, and in some cases a global positioning system (GPS) chip 215 that communicates with GPS satellites 250a-n. Software 214a-n may be machine-readable code that is stored on a storage media, or downloadable over a network connection, and installed on a mobile computing device 210. A user, in store location 242 in this example, uses device 210 to snap a picture of tag 240, which tag contains a special one-dimensional or two-dimensional bar code 241. The user clicks on application 213 contained in device 210 and follows the instructions that appear on the screen, thus pulling up additional data from the merchant in whose store the user is currently shopping or “browsing” (in the physical store).

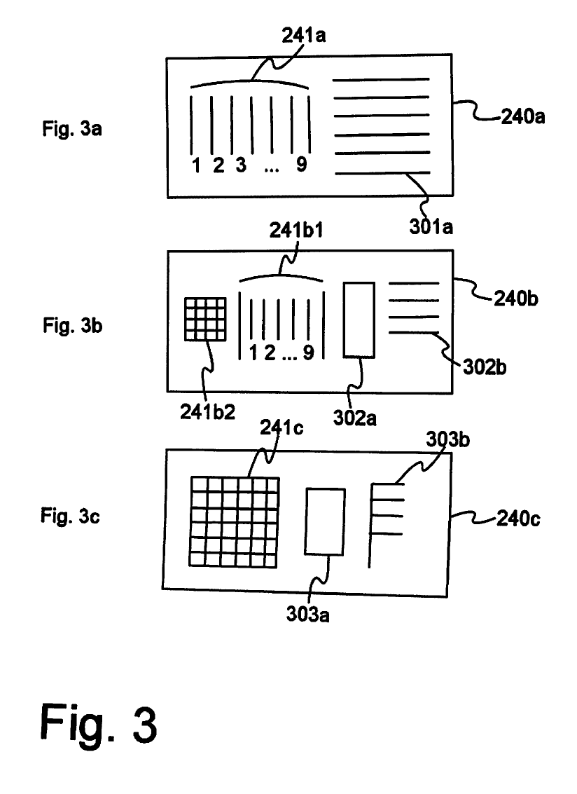

FIG. 3 shows different variations of label 240 according to various embodiments of the invention. In FIG. 3a, label 240a has a standard bar code 241a and a legible description 301a. By using either one or multiple of the GPS addresses or the IP address of the local wireless network or cell phone network/WAN network tower triangulation or a network tower IP address, the system and method disclosed herein is able to determine a location of a user who has taken a picture of label 240 and invoked application 213. The system can then pull up appropriate data (item/information/promotion) from a database of the merchant selling the item to give additional information about the selected product and/or special offers. In some cases a server 231a-n has the needed data (item/information/promotion); in other cases, server 231a-n may refer the user to a merchant's website, using cookies or similar tracking methods to enable the operator to get credit for the transaction.

FIG. 3b shows a different label 240b with a two-dimensional merchant bar code 241b2, as well as item bar code 241b1. Combined, these two bar codes can deliver all information necessary to provide a user with item URL/information/promotion for items. Label 240b also carries additional information including legible information 302b and picture or other indicia 302a.

FIG. 3c shows label 240c, which has a high-resolution two-dimensional bar code 241c, which bar code contains data about the merchant, location, shelf, item information, etc., associated with a product, as well as a link to an appropriate web address (universal resource locator or URL). That URL may be, for example, directly embedded in the label, to enable faster data retrieval with less processing. Additional indicia 303a may have a picture or sales promotion on the label and section 303b may have legible text.

In all cases, these labels 240a through 240c could be small liquid crystal display (LCD) screens that could be updated by a merchant's computer, rather than printed labels that need to be manually changed from time to time.

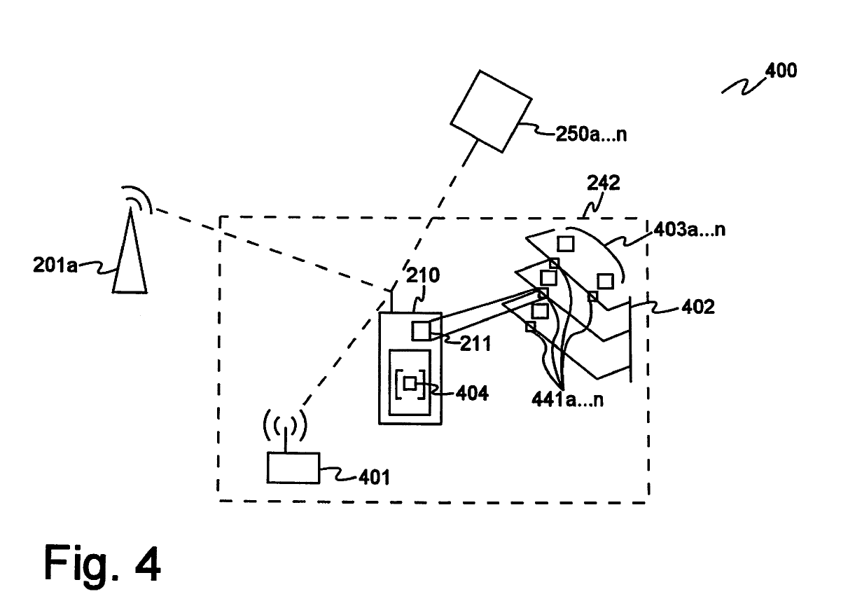

FIG. 4 shows a detailed section 400 of store location 242, mentioned in the discussion of FIG. 2. A user's device 210, with camera 211, scans or takes a picture of a label attached to a shelf 402a in front of merchandise 403a. Labels 441a-n are attached to shelves near items, so they can be scanned or photographed by the user's device. On a screen of device 210 a label appears as image 404. When image 404 is between the directional brackets, a user pushes a button to activate software according to an embodiment of the invention, or in some cases when image 404 is held stationary for a predetermined period, for example, 1 to 3 seconds, said software is automatically activated. Depending on how user device 210 is networked at that moment, device 210 may then connect to wireless LAN 401, and use the merchant's network, thereby using the merchant's IP address to determine the identity and location of the merchant. In other cases, device 210 may connect to cell tower 201a or other suitable 3G, 4G, or 5G or other network as available, or it may use GPS satellites 250a-n and determine the merchant accordingly. In some cases, merchants may offer an open network that permits only connection to their website and service server 220, so users can obtain information. Such an approach may be most suitable, for example, in locations where no WAN network is available, or where GPS does not work reliably, etc., due to building materials, such as concrete, metal roofs, etc., or for other reasons.

FIG. 5 shows an exemplary process 500 for implementation of a system according to a preferred embodiment of the invention. Most code shown in FIG. 5 executes on user device 210, but according to various embodiments, a lesser or greater amount of code may execute on server 220 or any other suitable server where software may be installed and accessible to user device 210. In step 501 an application is launched and configures its data. In step 502 the application checks that location services are on. In step 503, the application checks for availability of location services. If services are not available (indicated by “−”), the process moves to step 504, where the application tries to get a geographic location from a network or, in step 505, by resolving an address of a 3G, 4G, WLAN or other, similar wireless network. The process then loops to step 506, or, if location services were available when checked in step 503 (indicated by “+”), the process moves directly to step 506. In step 506, the application engages a camera of user device 210. In step 507, the application checks to see if it finds a bar code. If no bar code is found, the process loops around to step 508, where a timeout occurs, which timeout may be, typically, about 10 seconds. This timeout is inserted to avoid draining the battery of user device 210. If a timeout has expired without success, the process ends at step 509. Users can relaunch the application, or in some cases the application may be waiting in an idle screen mode, and users can turn the camera back on. The process then starts again at step 501, because a user may have changed location. In step 507, if a bar code is found (indicated by “+”), the application then turns off the camera in step 510 and in step 511 sends an image to server 220, expecting to receive in return a link to information (which could be a web address or URL), or information itself (e.g., XML data), as described earlier (see the discussions of FIGS. 2-4). In step 512, the application receives data from server 220, and in step 513 the application goes to a browser page specified in received data, on which page, for example, additional product information or promotional material, is displayed on a device screen to the user. Such material may, for example, include a countdown offer, such as, if the item is purchased within the next ten minutes, for example, an additional discount or benefit may incur.

It is clear that the partition between the application on user device 210 and software on operation center server 220 may be changed in many ways. Server 220, typically, looks in its database contained in mass storage 221 to find a URL of the merchant and adds a cookie to identify that this visitor has been sent by the system. This approach enables the system operator to participate in the economic benefit of the system and method disclosed herein.

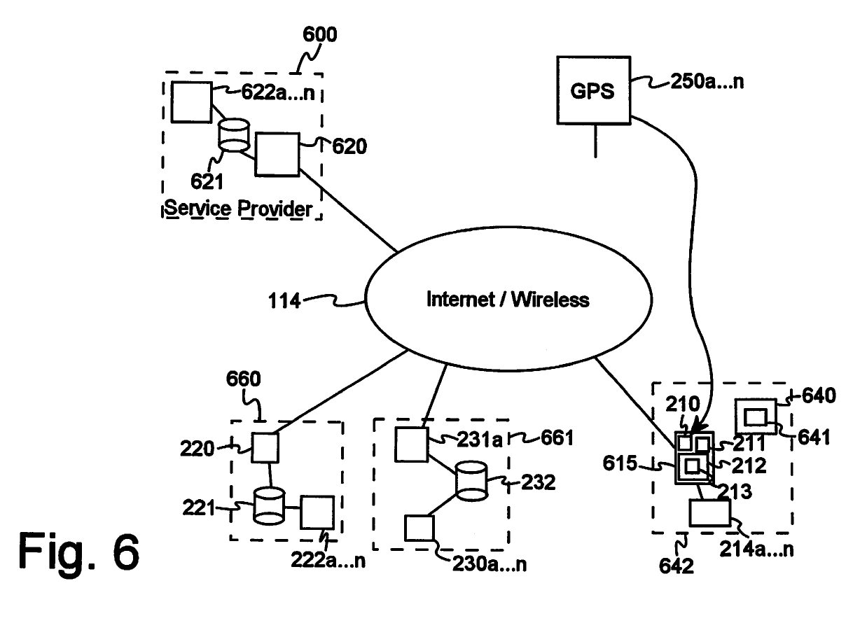

FIG. 6 provides an illustration of a preferred embodiment of the invention, in which some functions of a system or method of the invention are carried out “in the cloud” by one or more third-party service providers 600. Service providers, according to the embodiment, are generally equipped with server 620, like server 220 a computer of the type described with reference to FIG. 1, that carries out all or some of the functions described above with reference to server 220. Similarly, database 621 stores data pertaining to merchants, customers, products, and the like, and makes the data available via server 620 to one or more merchants 660, 661 or consumer mobile devices 210. Similarly programs 622a-n provide the service of the system and method disclosed herein. According to the embodiment, service provider 600 provides some or all of the functionality carried out, in embodiments described with reference to FIG. 2, by merchants that operate servers 220 and 231a-n. Similarly, consumers with mobile device 210 can access services, according to embodiments of the invention, by scanning or photographing labels 640 containing codes 641 while at a retail outlet 642 associated with one of the merchants, or with one of the merchants' business partners.

As an example of the various ways in which functions described herein may be distributed among one or more service providers 600 and a plurality of merchants 660-661, a service provider acts as an information aggregator for a plurality of merchants, each of which independently operates a server 230a-n, 220 according to the invention. By aggregating information from a large number of consumer visits to a variety of retail establishments, service provider 600 is able to provide each merchant with a richer consumer profile and behavioral history than would have been possible if the merchant operated solely using its own acquired data. Similarly, service provider 600 may advantageously facilitate partnerships between merchants in which merchants may share data and cross-promote items (related or not) to enhance consumer information and buying choices in a way that allows merchants to derive more sales from each visit to a retail establishment. For example, a bank and a food merchant may cooperate to promote use of label-scanning using mobile applications 214a-n in order to make such applications attractive to consumers. If a bank operates branches within one or more facilities of a food merchant, such cross-promotions can bring immediate tangible results, but even when banks and food merchants are not collocated mutual support of their respective brands may enhance utility of mobile device 210 for consumers and may concurrently enhance the respective bank's and food merchant's brands.

In another preferred embodiment, merchants 660-661 may participate in services carried out by the invention without operating any equipment on their own premises. Thus, in this embodiment, there would be no servers 220, 231a-n. Rather, merchants could optionally upload product and promotion data (and data pertaining to codes printed or displayed on labels 640) to database 621 in service provider 600, or they could make data in database 221, 232a-n available to service provider 600 via a web services interface or other communications means known in the art. In this way, merchants of all sizes could participate in services using the invention without having to maintain separate hardware or separate applications. By uploading (or making accessible) their data, merchants 660, 661 would be able to use labels 640 in their facilities to add value to consumers' retail experience. For example, when a consumer starts an application 214a-n and points camera 211 in mobile device 210 at label 640 containing code 641, data captured from the scan or photograph (which as before could include merchant identifiers, product identifiers, detailed location information such as shelf and position identifiers, and data pertaining to promotions associated with the product with regard to which label 640 is posted), is transmitted to service provider 600 and processed by application 622a-n. Application 622a-n would then gather appropriate data from database 621 and send it to application 214a-n on mobile device 210, thus enabling the consumer to view additional information about the product, promotions related to the product, other products that might be of interest given the context, and so forth. It will be appreciated that the ability of service provider 600 to aggregate data from retail interactions at many merchants' facilities will enable service provider 600 to provide much richer services to merchants than any one merchant could achieve on its own, while also allowing merchants to take advantage of the invention with less up-front investment.

It will be clear to one having ordinary skill in the art of cloud-based merchant systems that such an arrangement of inexpensive coded labels 640 and user-friendly consumer applications 214a-n will enable many diverse use cases according to the invention, and that the examples provided herein are merely that: examples.

It is clear that many modifications and variations of the system and method disclosed herein may be made by one skilled in the art without departing from the spirit of the novel art of this disclosure. These modifications and variations do not depart from its broader spirit and scope, and the examples cited here are to be regarded in an illustrative rather than a restrictive sense.

According to most embodiments of the invention, a customer must have a web-enabled mobile device, such as a smart phone, with a software application installed, which application can read one-dimensional and two-dimensional barcodes, identify a store in which a barcode is read, and modify the software's code-to-URL conversion rules and produce URLs for an appropriate store. Upon detecting a suitable machine readable indicia, the device processor calculates an indicator based on said indicia, and uses said indicator to obtain data relevant to an object related to said machine readable indicia, and then displays part or all of said data relevant to an object related to said machine readable indicia. This retrieved data may be retrieved from a server on a network, such as, for example, the Internet. In some cases, the calculation may be performed on a server reachable through a connection to, for example, the Internet.

A number of proprietary and public domain one-dimensional and two-dimensional barcode readers are available in the art to satisfy the first requirement of the application.

In some cases, to identify a store (or more generally, a merchant, used here interchangeably), a mobile device may obtain its geographic location information and match it with geographic locations of stores or merchants in a database. If a location match is found, the corresponding store is considered to be the one where the barcodes are being read. In other cases, stores conspicuously present at each entrance and inside their facilities a one-dimensional or two-dimensional barcode that uniquely identifies the store; for instance, the barcode may encode the store name or other pertinent information. In yet another case, the mobile device may detect a local wireless network and identify the store with a query to this network. In other embodiments, a user may type a store name in the software application on the mobile device, speak the name of a store for subsequent voice recognition, create a handshake between the mobile device and a terminal reader using radio frequency identification (RFID) antennae or near-field communication, Bluetooth exchange, or select it from a menu.

To modify the software's code-to-URL conversion rules and produce URLs for an appropriate store the software may use, for each store, a hard-coded or updatable schema for converting a merchandise code into a corresponding URL. In other cases, the software may download a schema for an identified store and use it for converting a merchandise code into a corresponding URL, or alternatively, the software may download a perishable executable code from a local network or an identified store URL, which then provide a suitable code-to-URL conversion.

In some cases, a user may bring a friend, family, or social group to a retail store, at which store they may scan a “group” version of a code at the location. All those that do within a certain time period or a certain geographic range get an offer from a merchant specific to that group. Such an approach may be termed “car pool” loyalty or rewards.

In some cases, the notion of “targeting” specific offers is partially derived by a user ID or a user's device ID, which is authenticated and registered. During registration, the system gathers demographic detail about a user and/or a user device 210, which assists in targeting relevant offers. Other data may be collected from subsequent transactions. In some cases, “multipolar” profiles are used, to account for cases such as, for example, where a parent buys for a child or spouse.

In other cases, the system knows not only relevant data about a user (gender, age, location, etc.) but also the user's prior transaction history where prior history could include items scanned (for example, a user scanned and got information about a particular product but didn't purchase the product, which information becomes a valuable marketing indicia that may for example indicate future buying preferences) or actual purchase history (for example, knowing a user buys Crest™ versus Colgate™ toothpaste, or knowing that a user purchased a Sony™ LCD, the system could deliver an offer for high definition media interface (HDMI) cables or a Blu-Ray™ DVD player, rebate details or an extended warranty offer), as well as, for example, including but not limited to, one or more of time-of-day, location, prior and following location to transaction, day of week, date, etc.

In further cases, location-based services can be used for verified “check in” at a store. For example, a user can scan a code when entering Whole Foods™, and thence the system has available who the user is, where he is, what merchant type (grocery) and branch, when (time and date). All the previous are valuable information that could enable time-sensitive offers. For example, if Whole Foods™ knows it has excess eggs, the system could retrieve data from their inventory management/enterprise resource planning (ERP) system to offer consumers eggs at a discount, in particular to those who have bought them in the past. Also, when scanning the code, referencing prior transaction/purchase history enables additional targeting. For example, entering Whole Foods™, a user scans a code, the system looks at the user's history and, knowing that the user buys Coke™ versus Pepsi™, the system could deliver a targeted ad for one of those or a related beverage product.

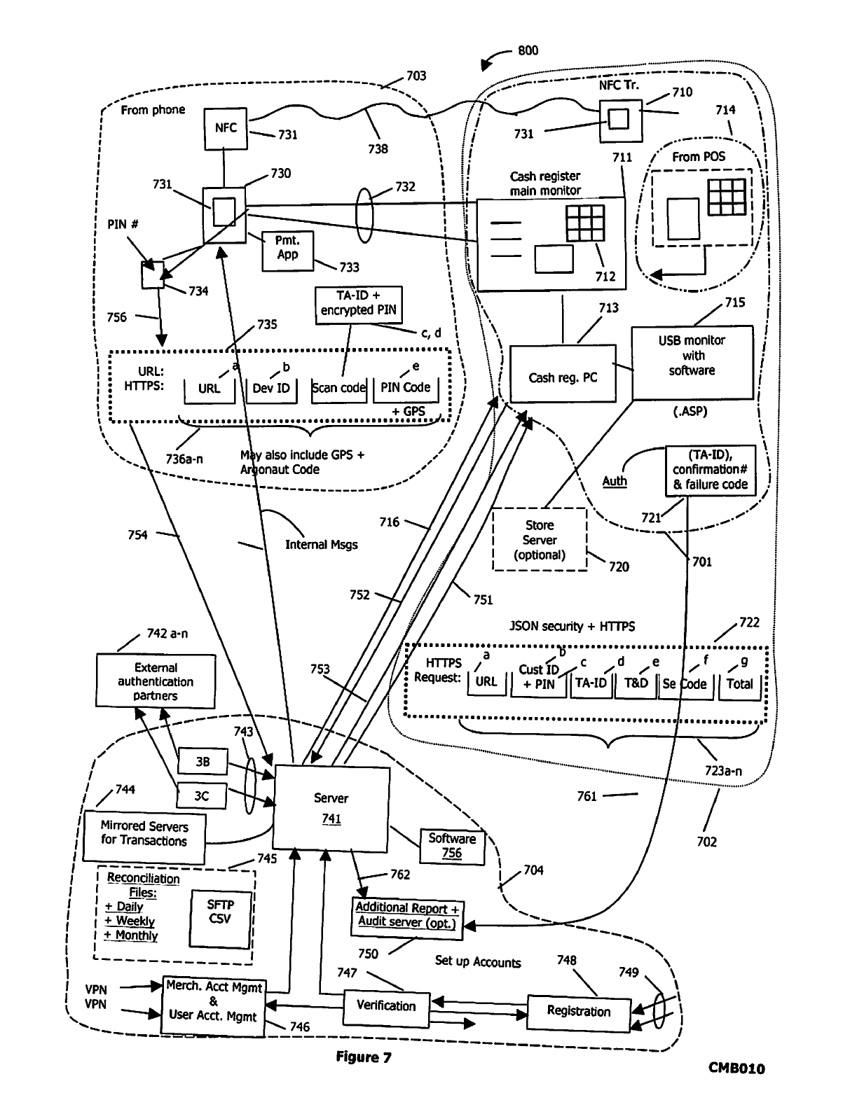

What is further needed, and is illustrated in FIG. 7, is a system and method for connecting the code of a nonce and the two entities (merchant or manufacturer and consumer, for example) involved in a transaction. Such a system and method is akin to the use of near field communication (NFC) chips (NFCCs, further explained below) and can actually be used in parallel with, or in lieu of, or in conjunction with an NFC transaction, as indicated by NFC chips 731 (for example, on or within customer device 730 and NFC-enabled keypad/credit card pad 710 at the cash register), described below. NFC transactions laid out a path for contactless card transactions that count as “card present” and hence are more secure and qualify for lower risk and associated costs. The requirement for NFC transactions is that both merchants and customers have NFC chips in their respective devices. In particular in the U.S. there is a high resistance by merchants for installing additional hardware, such as hardware with NFCCs, because of the additional cost, and therefore, reluctance by phone manufacturers to spend money on NFCCs that are unlikely to be used.

In some cases system 700 may include a server 741, a computing-device-based cash register 713, and a wireless computing device 730, wherein register 713, upon totaling a sale amount, requests from server 741a visual indicia nonce, displays said indicia on screen 711, allowing a customer to capture said nonce with his wireless computing device 730 (including web-enabled mobile devices), and confirming said transaction by entering his PIN 734, the captured nonce and pin then being sent on to server 741 from mobile computing device 730 for verification and securing funds from the customers account. Further, in system 700 described above, a PIN may be only stored at server 741 in a local storage; and/or a customer's monetary account information may be only stored at server 741 in a local storage. In some cases, a customer may be identified by a device ID of his mobile computing device 730, and in yet other cases, said ID may be stored during a registration including a PIN and one or more financial institution information elements including some monetary account information. System 700 may include software in a machine-readable format, installable on mobile computing device 730, which allows capture of a visual indicia containing a nonce, and transmitting information contained in said visual indicia with additional identifying information such as a device ID 735b in a single packet 735 to server 741. Additionally, a customer may be prompted to enter a PIN and said PIN 735e may be also transmitted to server 741. Further, system 700 may include software in a machine readable format, installable on a computing-device-based register 713, wherein said software can request from server 741a visual indicia containing a nonce, said nonce containing at least some information to a location and a merchant operating said register or an index to that information on server 741, and displaying said nonce on at least one screen 711 visible to a customer. Additionally, information such as a total amount 722g may be sent to server 741, and total amount 722g may be included along with information of visual indicia containing a nonce in a data packet 722, or indexed on server 741 by the visual indicia containing a nonce.

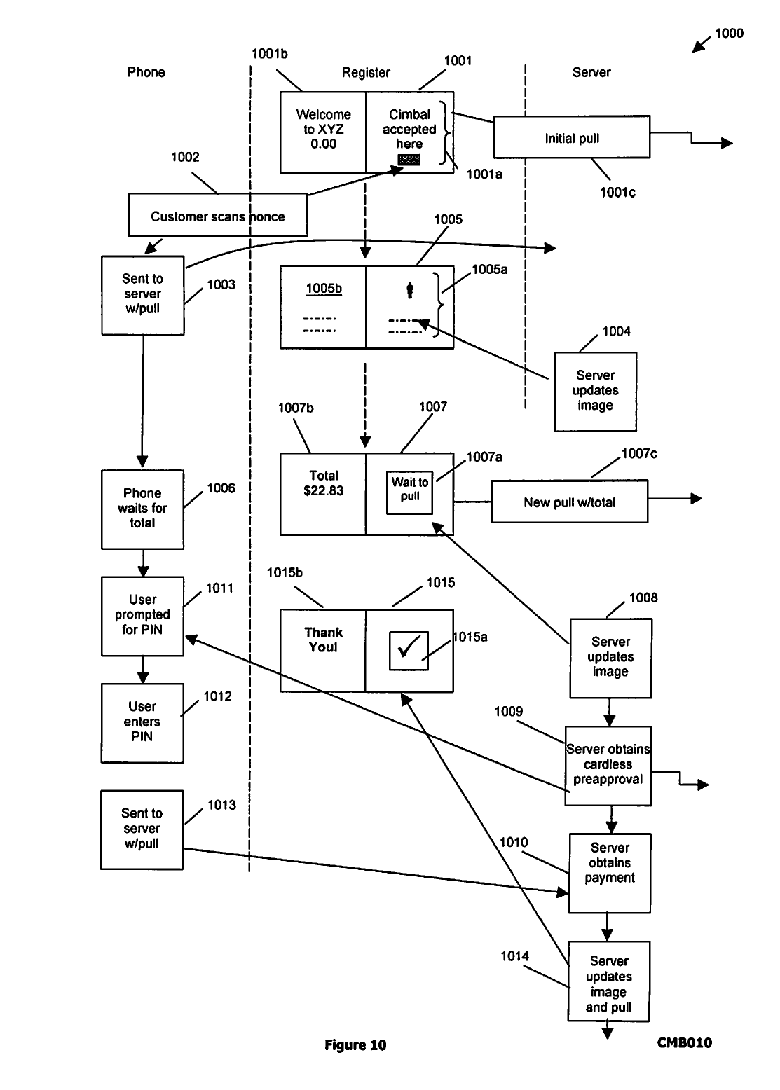

FIG. 7 shows an overview of an exemplary system 700 for multipath contactless transactions according to an embodiment of the invention. Within area 701 is a cash register module; within area 702 is a merchant module, which includes area 701 and elements 722 and 720, discussed further below; within area 703 is a consumer hand-held device module with various interactions; and within area 704 is a clearance module, with connections to external entities 742a-n that are used for verification of identities at registration of both customer or merchants, as well as authentication or nonces for NFC transactions or other authentication nonces for contactless transactions as required or requested. In a typical transaction the cash register 713 has a display 711 that shows, on its left side, a list of billed items. Also shown is a typical NFC-enabled keypad/credit card pad 710 with built in NFCC 731. More details about the content of display 711 shown at different stages of a transaction are disclosed in the description of FIG. 10, below, as well as throughout this document. The description here focuses on using an existing screen at a cash register and a camera in a typical smart phone or feature phone to make a contactless transaction in lieu of or in addition to a contactless NFCC transaction, as indicated by squiggly line 738. However, it is clear that NFC chips can be used the same way to make enhanced transactions as described herein, beyond their current use, and hence, even though NFCCs are not mentioned in each aspect, these expanded features of a contactless transaction using NFCCs should be considered novel as well and covered herein. When a total is calculated, cash register 713 pulls an image 712 by sending URL 722 to clearing house server 741. URL 722 comprises actual URL 723a, merchant ID 723b and cashier PIN 723c, transaction ID 723d, other transaction information and data 723e, security code 723f, and transaction total 723g. This transmittal may be made as an HTTPS request 722, using enhanced JSON-based security, which is described at http://en.wikipedia.org/wiki/Json. JSON-based security can provide 4096-bit encryption for a URL and for all data sent, thus enabling a transaction to be more secure, but other, similar security enhancements can be used in addition to or in lieu of JSON-based security. Augmented URL 722 is passed to server 741, as indicated by arrow 752, and server 741 then verifies merchant (and/or in some cases customer) information, etc., and then creates a nonce displayed as an image 712 in the form of a two-dimensional barcode within a page (typically HTML based) on display 711, by returning image 712 as part of an HTTPS transaction, indicated by arrow 753. In some cases an additional universal serial bus (USB) or other monitor within area 714 may also be attached, displaying a short version of relevant items and displayed nonce 712 in a more convenient location for a customer to scan with his device 730. Once an image of nonce 712 appears, with a mobile communication device 730, such as a cell phone or other, similar device, the customer scans image 712, as indicated by vision line 732 with an application (such as application 733) using a camera (not shown) of mobile device 730, which most smart and feature phones or similar computing devices (for example, iPod Touch™, etc.) do have. Once image 712 has been successfully recognized, the payment application 733 running on customer device 730 continues the transaction. It can be a “clickless” scan, meaning there is video or a fast sequence of snapshots until the image 712 (containing nonce image 712) is scanned and recognized. At that point, the application causes device 730 to beep and/or vibrate and the customer is prompted to enter a PIN on device keyboard 734, thus making skimming of pin numbers by unintended third parties nearly impossible. That information is then sent as a URL 735 over HTTPS with JSON, similar to URL 722 (in both cases other security methods maybe used in addition to, in lieu of, or in combination with JSON, without departing from the scope of the invention; it should be well-understood by one having ordinary skill the art that there are many alternative security methods that can be used) and indicated by arrows 754 and 756, which lead, in sequence, to server 741. The web service interacts with software 756, for example, in the form of an “.asp” web transaction, allowing multiple updates of the results as the transaction or parts of it progress. Other formats could be used, such as for example Java servlets; again it will be understood by one having ordinary skill in the art that there are many ways to delivering web content in a dynamic way. URL 735 forms an HTTPS request and contains an actual URL 722a (which URL may be the same or different from URL 722); an ID 722b of customer device 730 (unique ID used by device manufacturers to identify devices for their own application stores), which was previously registered (registration process discussed separately); a scan code, meaning the numeric value of the nonce, which includes a transaction ID 722c and sometimes an additionally encrypted version of the PIN 722d, and/or a PIN code passed as a separately enclosed item 722e. PIN codes are preferably not stored on device 730, and any temporary buffers are eliminated at the end of each transaction. It is clear that in the cases of both URLs 735 and 722 there may be additional parameters or, similarly, some parameters may be omitted. This enhanced URL 735 is then sent to server 741 in the form of an HTTPS request. As an option, in cases where available, a selection may be made on mobile device 730 indicating which funding source is being used for payment of a transaction (for example, checking account, debit or credit cards, stored value or gift cards, etc.) by offering an option to change from a default funding source. Server 741 then verifies availability of funds and reserves said funds through interactions 743 with external authenticators 742a-n. Server 741 also requests a unique token based on a funding source and if appropriate, a card association (Visa, MasterCard, American Express, Discover, etc.) as well as the issuer of the applicable account (Bank of America, J.P. Morgan Chase, Citibank, Wells Fargo, etc.). This token may be comprised of an account number, device identifier, device authenticated PIN and issuer key, among other elements to equate to a “card present” transaction. When server 741 receives a confirmation, it updates image 711 with, for example, the code “PAID” via arrow 751, and it may send additional confirmation to customer device 730, as indicated by arrow 755, as well as financial system confirmation or failure code 721 to the merchant's system, as indicated by arrow 761 through audit services 750 and arrow 762. Server 741 can separately notify cash register module 713, as indicated by arrow 716, that payment has been received. Interaction module 715 in cash register module 713 then clears the payment. In some cases, multi-cashier merchants may have a store server 720 that takes the primary interaction to clearing server 741; in other cases, this server may not be necessary. All references to the “server” participating in transactions are referring in the broadest sense to server 741 in conjunction with transaction software 756. Further, there could be one or more physical or virtual servers 741 running at a clearinghouse location, or in the cloud, or in both, in any combination. Moreover, in some cases server 741 may be physically located on a single computer as a virtual machine image, and in other cases 741 may be a single logical software element distributed across multiple physical computers using technologies such as clustering.

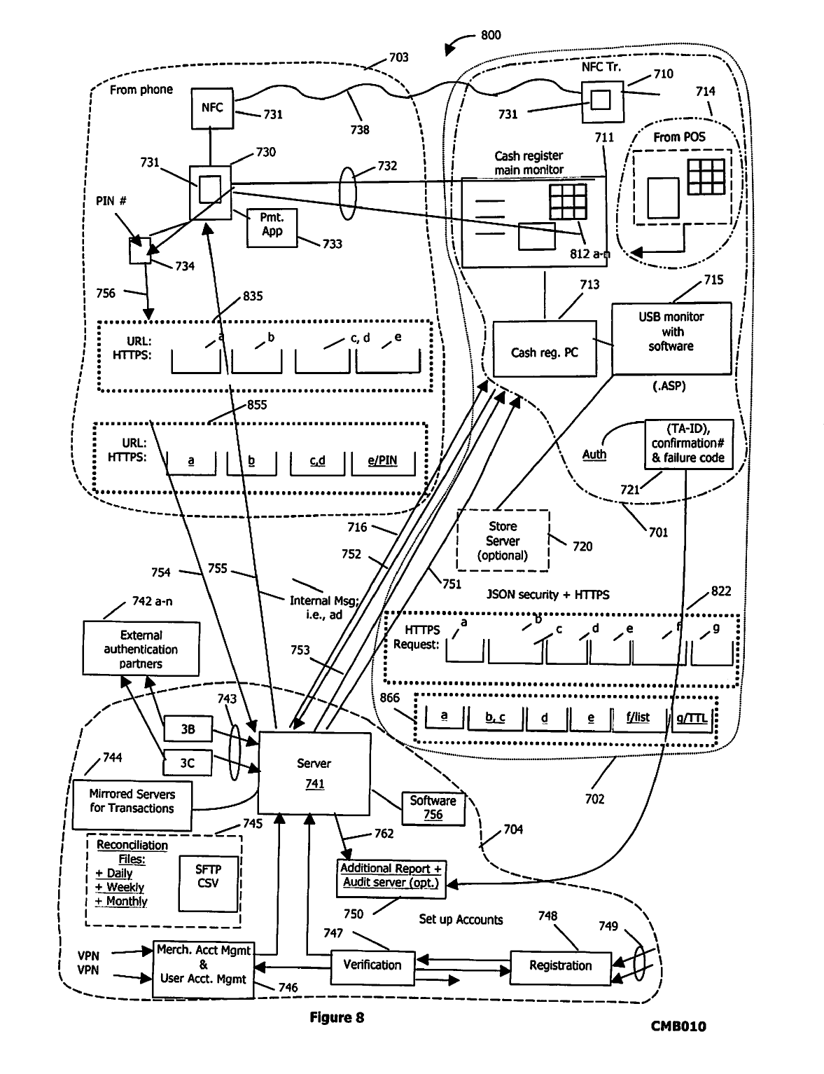

FIG. 8 shows an overview of an exemplary system 800, according to a further embodiment of the invention. System 800 is much the same as system 700, shown in FIG. 7, except that if a customer participates in a merchant loyalty program, a nonce may appear on display 711 at the “opening” of a transaction, before a total has been established, which is indicated by arrow 752, which is an HTTPS request in the form of URL 822. That pull (HTTPS request) results in an image 812a of the nonce, which image typically contains a store location and a register ID, as well as some additional information, including in some cases security information. When a customer scans a picture of nonce 812a, a transaction pull is made on device 730, as previously explained in the description of FIG. 7 above. However, rather than a total, merchant location and cash register information is sent in the scanned nonce as part of an HTTPS request/pull using URL 835 to server 741. This information lets server 741 (broadly in conjunction with software 756 and possibly other servers not shown) connect the customer with a pending transaction to a specific cash register lane at a specific merchant location and a specific open transaction (started by pull with URL 822). Both cash register 713 and customer device 730 are kept in a transaction-pending mode. While a transaction is pending, in some cases, a special greeting may be shown, in other cases a profile picture of the customer may be shown, etc, as image 812x, as well as information about discounts due to the customer's membership in a merchant loyalty program may be invoked and displayed on the transactional details side (left half of the screen in this example) When the transaction is closed after all items have been scanned by a cashier, a second URL pull 866, similar to pull 822, is done by cash register 713, for example under control of software instance 715 (which in some cases may be as simple as a script or URL embedded in HTML code, resulting in a new nonce image in location 812y, further described below. When server 741 receives the second HTTPS request 866 from cash register 713, server 741 then creates a total and sends an internal message, as indicated by arrow 755, to customer device 730. Customer device 730 now displays the merchant's name, the total amount, and possibly other relevant information, such as membership savings, etc., and prompts the customer for his PIN to confirm payment. This customer action results in a second HTTPS request 855 with device ID, PIN, etc, similar to HTTPS request 735, the second request's main difference with respect to the first one being that totals and other final transaction details are known (for example itemized list 866f and total (TTL) 866g of transaction, as well as customer PIN 855e), while at the first request, a total as well as the customer's PIN confirming the transaction at that merchant for the total cannot be included, as during the first requests the transaction is just beginning or still ongoing. This approach allows a customer to avoid having to do two scans, once for the membership card and once for the total, as is necessary, for example, with club cards today, which require that club cards and payment cards be scanned separately. The two-step transaction described here enables both a simpler transaction for a customer (one scan only for both loyalty membership sign-in and payment), as well as a clearing of contactless payments per the requirements of the credit card industry to qualify for contactless card present transactions. In some cases, additional interaction may be added in a similar manner, to allow adherence to specific protocols, such as including but not limited to EMVCo Contactless Specifications for Payment Systems 2.1 (more info at http://www.emvco.com/specifications.aspx?id=21), MasterCard extensions of protocols (more at http://www.paypass.com/documentation.html), Visa extensions (more at https://technologypartner.visa.com/Library/Specifications.aspx) as well as other relevant players in that segment.

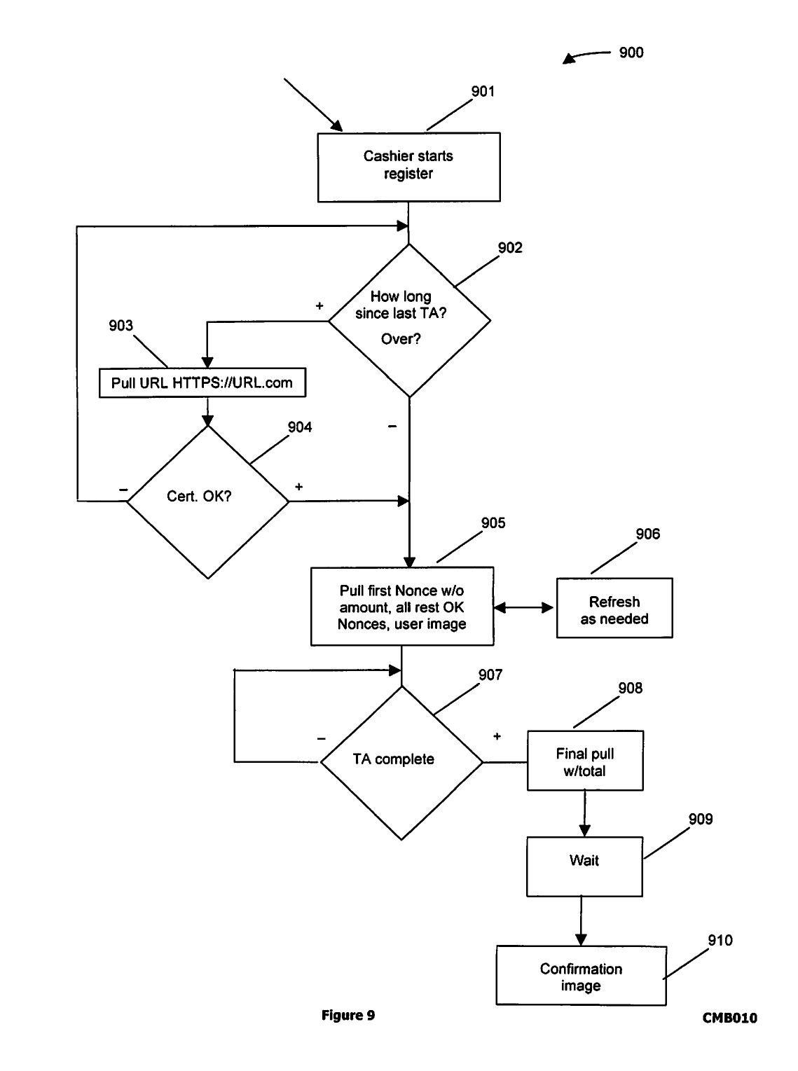

FIG. 9 shows exemplary process 900 of a transaction at a cash register, according to an embodiment of the invention. At step 901, a cashier checks in. The system then checks the amount of elapsed time since the last transaction at the register, in step 902. If the time is within a preset duration (indicated by “−”), the process moves to step 905, described below. If the time is greater than a preset duration (indicated by “+”), then in step 903 the system makes an empty URL pull on the HTTPS, to avoid a “man-in-the-middle” attack, wherein a URL is spoofed because the initial pull could be misdirected, allowing an attacker to gain access to merchant information contained in the URL. Doing an empty pull with no data, just a request for an empty page, enables the system to verify that the security certificate is still valid and there has been no DNS manipulation or man-in-the-middle attack. If the certificate checks out as OK (indicated by “+”) in step 904, the system moves to step 905. In step 905, the system makes the first pull, such as, for example, pull 722. If the transaction is kept open for more than a preset length of time, for example, because many items need to be registered, in step 906 the system refreshes the pull or the .asp (or Java servlet) refreshes the results page on its own. Typically, a nonce has a stated lifetime, and when it expires, the nonce is refreshed. When the transaction is complete in step 908, the final pull occurs in step 908, with the total (in previous examples elements 722 and 866). Then in step 909, the system waits until, in step 910, it receives confirmation information and/or an image from server 741 (not shown).

FIG. 10 is an overview of an exemplary set 1000 of interactions among a customer's mobile communication device, such as a smart phone, a merchant's cash register (mainly the screen), and a system server during a typical cash register transaction. At the beginning, display 901 shows, on the left, a merchant welcome window 1001b. On the right side is a welcome window 1001a that appears with the first pull, described in the discussion of FIG. 8, above as element 822. This initial pull 1001c connects to server 741 (not shown here). At step 1002 the customer scans the nonce. This step need not occur at the beginning of transaction interactions; it can occur at any time while a cashier is still ringing up items. When a customer scans the nonce, at step 1003 the customer device 730 (not shown here) sends the scan to the server 741 (as a pull, for example, element 835 in FIG. 8). At step 1004, the server updates the image in display 1005. Window 1005a now may show a profile image of the customer, for example, or a personalized greeting, or some special promotion, etc. This update from server 741, can also identify the customer (or his/her membership ID) to the merchant register and thus enables the register to deduct discounts for membership cards, etc. The ongoing transaction, which could include deductions made for promotional items, is shown in window 1005b. At step 1006 the mobile application waits for the total. When the transaction is complete and the amounts are total, the total appears on display 1007 in window 1007b, while window 1007a displays a “Waiting” message while the register sends a new final request, such as request 722 from FIG. 7 or request 822 from FIG. 8, to the server 741. At step 1008, the server updates the image in the windows in screen 1015. The server also sends a message, at step 1009, to one or more external authentication partners 742a-n for contactless card present transaction to verify funds and reserve them, upon which the customer is prompted to confirm the amount and merchant by entering his pin in step 1011. After the customer enters his PIN in step 1012, a final pull is made in step 1013 (for example, pull 855). Then, at step 1010, server 741, after matching the customer-provided PIN with the PIN stored for this customer ID in its vault, finalizes the transaction with external partners to obtain the funds. Following step 1010, in step 1014, server 741 sends additional messages to cash register 713 to update the screen to display 1015, which show, in window 1015a, a checkmark, or “PAID” notice, or some similar indication that the transaction is closed, as well as, in some cases, additional messages to audit servers, etc. In some further cases, server 741 may obtain a fully detailed list of the transaction from a merchant system for paperless receipts that can be forwarded immediately to a customer's device, for example, as well as for additional statistical analysis. By providing separate paths for authentication in real time using two authenticated devices, and not requiring a customer to enter any data (including but not limited to his or her PIN) a higher level of security is achieved, and skimming of account and PINs are no longer possible.

It is clear that many modifications and variations of the system and method disclosed herein may be made by one skilled in the art without departing from the spirit of the novel art of this disclosure. For example, in some cases the system may include a server, a computing-device-based register 713 (including, but not limited to, an online shopping cart for electronic commerce), and a wireless computing device 730, wherein the register, upon totaling the amount, requests from server 741 a visual indicia nonce, displays said indicia on a screen, allowing a customer to capture said nonce with his wireless computing device, and confirming said transaction by entering his PIN, said captured nonce and PIN then being sent on to server 741 for verification and securing funds from the customers account. Further, in the system described above, the PIN may be only stored at server 741 in a local storage; and/or the customer's monetary account information may be only stored at server 741 in a local storage. In some cases, a customer may be identified by a device ID of his mobile computing device 730, and in yet other cases, said ID may be stored during a registration including a PIN and one or more sets of financial institution information including some monetary account information. The system may comprise software in a machine-readable format, installable on a mobile computing device 730, which allows a capture of a visual indicia containing a nonce, and transmitting information contained in said visual indicia with additional identifying information such as a device ID to server 741. Additionally, a customer may be prompted to enter a PIN and said PIN may be also transmitted to server 741. Further, the system may comprise software in a machine-readable format, installable on a computing-device-based register 713, wherein said software can request from a server 741 a visual indicia containing a nonce, said nonce containing at least some information to a location and a merchant operating said register or an index to that information on server 741, and displaying said nonce on at least one screen visible to a customer. Additionally, information such as a total amount may be sent to server 741, and said total amount may be hence included in the information of said visual indicia containing a nonce, or indexed on said server by said visual indicia containing a nonce.

These modifications and variations do not depart from its broader spirit and scope, and the examples cited here are to be regarded in an illustrative rather than a restrictive sense.

All of the embodiments outlined in this disclosure are exemplary in nature and should not be construed as limitations of the invention except as claimed below.

What is claimed is:

1. A system for multipath contactless transaction processing, comprising:
a point-of-sale system comprising a processing unit and a video screen, the video screen at least sometimes viewable by a purchaser interacting with the point-of-sale processing system;
wherein, during a transaction, a graphical indicia is displayed on the video screen in a form suitable for photographing or scanning by a device held by the purchaser; and
wherein, upon receipt by the point-of-sale processing unit of at least one non-graphical indicia the content of which is determined at least in part by the contents of the graphical indicia that was displayed to the purchaser, the point-of-sale completes the transaction.

2. The system of claim 1, wherein an identity of the purchaser is provided within the non-graphical indicia.

3. The system of claim 2, wherein an information element displayed on the video screen after receipt of the non-graphical indicia is based at least in part on the identity of the purchaser.

4. The system of claim 3, wherein the information element displayed is based at least in part on the membership of the identified purchaser within a group.

5. The system of claim 3, wherein at least one purchase price of an item within the transaction is adjusted based on the identity of the purchaser.

6. The system of claim 1, further comprising a near-field communications radio device;
wherein in addition to receipt by the point-of-sale processing unit of the at least one non-graphical indicia, and subsequent to a transmitted request from the radio device, at least one response is received by the radio device specific to the request; and
wherein completion of the transaction by the point-of-sale device is performed only upon receipt of both the non-graphical indicia and the response received by the radio device.

7. A system for multipath contactless transactions, comprising:
a server connected to a packet-based data network and adapted to communicate via the network with a plurality of merchant database systems and to a plurality of point-of-sale systems;
a software module operating on the server; and
a data store coupled to the server;
wherein on receipt of a transaction request from a point-of-sale system, the software module computes a cryptographic nonce and sends the nonce to the point-of-sale system; and
wherein, on receipt of a response from a device other than the point-of-sale system that includes a first indicia based at least on the content of the cryptographic nonce, the software module validates the response and sends a message to the point-of-sale system containing at least a second indicia based at least in part on an identity of the user of the device.

8. The system of claim 7, wherein the second indicia is also based at least in part on membership of the user of the device in a group.

9. The system of claim 7, wherein the second indicia is also based at least in part on financial information provided in the response and is used to authorize the transaction.

10. The system of claim 8, wherein an image of the identified user of the device is transmitted by the software module to the point-of-sale system either as part of the second indicia or as a separate message.

11. A method for conducting contactless transactions, the method comprising the steps of:
(a) receiving, at a server, a first message indicating a pending transaction has commenced at a point-of-sale system;
(b) computing, in a software module operating on or in communication with the server, a cryptographic nonce for the transaction;
(c) transmitting the cryptographic nonce to the point-of-sale system in a second message;
(d) receiving a third message from a device other than the point-of-sale system comprising information known to be derived from the cryptographic nonce and at least information pertaining to an identity of a user of the other device;
(e) determining whether the user is authorized to complete out the pending transaction; and
(f) sending a fourth message to the point-of-sale system comprising at least an authorization code or a rejection code for the pending transaction.

12. The method of claim 11, further comprising the steps between steps (d) and (e) of:
(d1) determining whether the user is a member of a group;
(d2) transmitting an indicia of group membership to the point-of-sale system; and
(d3) receiving a proposed total amount of the pending transaction from the point-of-sale system.
